(19) United States
(12) Patent Application Publication
(10) Pub. No.: US 2012/0303351 A1
(43) Pub. Date: Nov. 29, 2012

(54) SYSTEM FOR OPTIMIZING THE OPERATION OF SOLAR THERMAL ELECTRIC PLANTS

(75) Inventors: Enrique Serrano Dorado, Leganes (ES); Ralf Wiesenberg, Leganes (ES)

(73) Assignee: SUN TO MARKET SOLUTIONS S.L., Leganes (ES)

(21) Appl. No.: 13/256,134

(22) PCT Filed: Sep. 16, 2010
(86) PCT No.: PCT/ES10/70602

§ 371 Date: Mar. 16, 2012

(51) Int. Cl. G06G 7/54

(52) U.S. Cl. 703/18

(57) ABSTRACT

A system is for optimizing the operation of solar plants 100 and for specifying the operating conditions thereof. A file transmission protocol (FTP) server 102 collects general prediction data of a data satellite service and an electric grid server 104 collects data referring to the public file market prices of the electric grid. The information compiled by both servers (102, 104) is supplied to expert modules (110, 112, 114, 116), compared and stored in a database 106 (DB), which is supplied to a control unit (120). A user (108) has the chance to manipulate it and work with each expert module by a user interface (118) for the purpose of defining the conditions suitable for operating and optimizing activities of the solar plant.

### FIELD OF THE INVENTION

The present invention relates to a system for optimizing the operation of solar thermal electric plants, as well as the aid for the operation thereof, and the definition of the technological infrastructure necessary for the integration with components such as dedicated servers, databases, configuration and control modules necessary for their operation.

### BACKGROUND OF THE INVENTION

Once a solar thermal electric plant is built, one of the critical points for the appropriate development of the commercial exploitation thereof is the operation criteria. Each power plant will solve the proposed generation objections, will be reliable and will make the economical and technical operation possible.

The present optimization system provides the information and prognoses of the primary energy that could be used, of the solar resource, and the objectives that will be solved, specifically referring to the electric demand, using a dynamic model of a thermal electric plant which reflects the physical and operational reality thereof (possible operating modes, control systems, inertias, etc.).

This approach to the predicted operation, obtained from simulations within a dynamic optimization environment, allows economically maximizing the exploitation in a plant or managing the possible restrictions which may occur in it, such as the use of the additional fuel, the limits or obligations of the energy injected into the grid by the operator, technical problems and maintenance activities, or the availability and management of the use of water for cleaning and refrigeration.

Therefore, there is a need in the art for a system which, in conjunction with data management and collection modules, allows an appropriate administration of gas and of the use of the thermal storage that can lead to an economic increase of up to 10% in the sale of energy produced by the plant by means of a single user interface.

### DESCRIPTION OF THE INVENTION

The system provided by means of the present invention comprises a plurality of operation modules within a system which puts them in communication with one another and manages them, which manage different necessary aspects relating to thermal solar plants, such as meteorological data compilation and prediction, plant operations, integration with the operating systems of the electricity market, among others, by means of a singe user interface.

The system allows specifying the operating conditions of the thermal electric plant, consulting the proposed production plan and exploiting the handled information to perform the necessary information management.

The system comprises a plant module in turn comprising a power plant model, with a system of solar thermal collectors, with the possibility of heat storage and an auxiliary boiler for the dynamic modules of the plant.

The system comprises a market electric module used to know the conditions of the electric system referring to a particular region and in its version of the price prognosis model which is connected to an electric grid server to obtain the necessary data.

An optimization module, in conjunction with the elements of the system, is designed to obtain prognoses on 24, 48, or 72 hours of the various meteorological variables, obtained from a meteorological module, of the solar plant location and of the sale prices and electricity demand that will be met.

The optimization module also comprises a series of sub-modules, such as the solar resource module consisting of a model that improves the estimation of direct solar radiation, which is a critical variable for this technology, but always taking into account the remaining meteorological conditions, such as the wind, humidity, temperature, etc. This sub-module incorporates self-didactic systems to reflect local and specific conditions of the location and of the meteorology which help in the exploitation of the plant, such as fog or suspended dust due to the wind. The demand prognosis can depend on the estimated electric market prices.

The module of the plant integrates a dynamic model which will be described below, including its control system and an operating mode editor, which are connected with an exploitation and optimization strategy administrator, from where the planning in the selected time horizon (24, 48 or 72 hours) will eventually be obtained.

There can be several criteria for optimizing production planning: maximizing the profit for the sale of the electricity by means of the predicted electric market prices, minimizing load fluctuations in the steam turbine, maximizing the operating hours, etc. Within this dynamic optimization, the additional use of fuel, the technical and operational restrictions and the thermal storage management, if it exists, are particularly important.

### BRIEF DESCRIPTION OF THE DRAWINGS

A series of drawings which help to better understand the invention and which are expressly related to an embodiment of said invention that is presented as a non-limiting thereof will be briefly described below.

FIG. 1 illustrates a diagram showing the architecture and interconnection of the system for optimizing the operation of solar thermal electric plants according to the present invention.

FIG. 2 shows a graph of the data referring to the solar resource available for the operation of the solar thermal electric plant according to the present invention.

FIG. 3 shows a block diagram representing the orientation of a solar thermal electric plant according to the present invention.

### DETAILED DESCRIPTION OF THE INVENTION

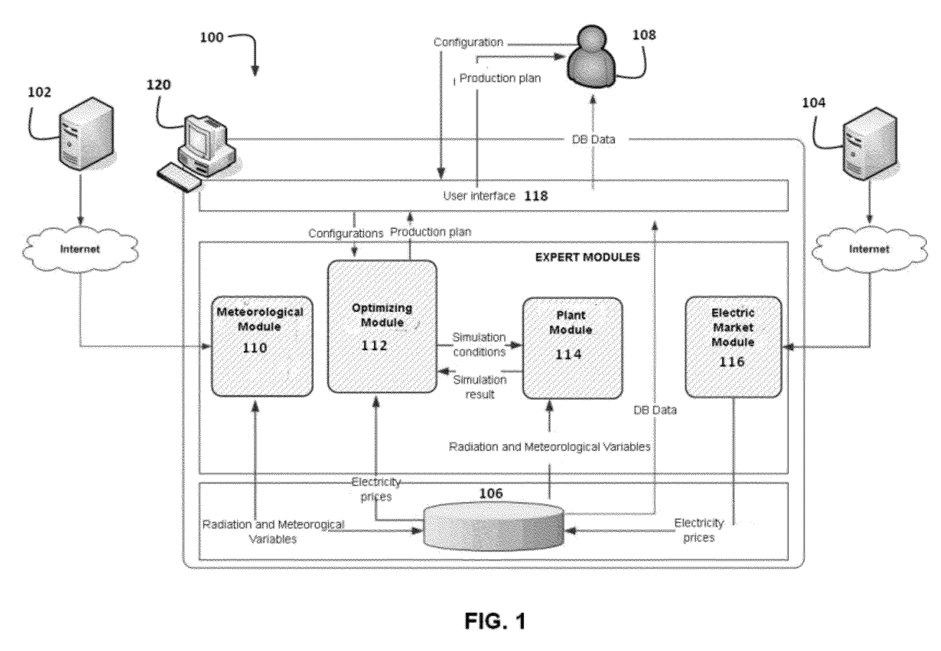

According to the diagram of FIG. 1, a system 100 for optimizing and specifying the operating conditions of a solar thermal electric plant, which is depicted by means of a plant module 114, consulting the proposed production plan, using the handled information to perform calculations (meteorological variables, market prices, etc.), which comes from a file transmission protocol (FTP) server 102 for housing it and comparing it in a database 106 (DB) and providing it to a user interface 118 of a control unit 120 so that the user 108 can manipulate it and work with each expert module (110, 112, 114, 116) intended for a particular function, is provided.

The inputs of the process can be specified, the information housed in the database 106 can be used and the results calculated by the expert modules (110, 112, 114, 116) can be collected by means of the user interface 118 of the control unit 120. The system further provides the mechanisms necessary for the expert modules (110, 112, 114, 116) to work in an integrated manner, providing an integral system 100 which allows each module to work in its context, resolving communications between modules.

The system 100 has sufficient capacity to be able to run the modules (110, 112, 114, 116) it uses, to house the database 106, to run the tools used by the modules (110, 112, 114, 116) and to provide access to Internet so as to allow the external connection of some modules, as in the case of the meteorological module 110, which requests information from the FTP server 102, which is connected to the Internet for the purpose of providing and comparing information between the database 106 and the meteorological module 110, which can comprise meteorological and radiation variables.

The system shows a plant module 114 which reflects the physical and dynamic reality of a thermal electric plant. A control system (not shown) receives the inputs from the plant model and can control it by means of reflecting the included reality through the data collected by means of the database 106, through an electric market module 116 and the meteorological module 110.

The plant module 114 comprises a dynamic model of the plant including the physical configuration and the main systems of the plant. The model considers the inertias (thermal and mechanical inertias, among others) and the synchronizations in the operating dynamic of the plant, being able to be adjusted and calibrated while the real experience of the operation is being obtained.

The plant is managed according to the operating modes, including the operating parameters of the plant subsystems and the logic thereof of the action. These modes are previously edited depending on the configuration and on the physical probabilities of the plant, which can be edited in the case of changes made by the user 108 either through the user interface 118 or through the initial parameters of the system 100.

The system 100 comprises also an optimization module 112 from where can be specified the parameters relating to the solar field, warehouse, gas and block, as well as the restrictions and criteria necessary for making modifications and performing simulations on the operation of the plant module 114, by means of which the real operation of the plant can be consulted.

For the purpose of providing a high security level to the system 100, as well as to the handling and management of the expert modules (110, 112, 114, 116), the database 106 controls the number of users 108 that can exist and can have access to the manipulation of the information of said database 106 and of the user interface 118 by means of encrypting information and passwords for accessing the system 100.

The infrastructure of the system 100 will be described below in further detail by means of analyzing the features and requirements of the components that form it. The analysis of the infrastructure of the system 100 comprises, as mentioned above, a series of expert modules (110, 112, 114, 116), considered as subsystems, which perform a specific function, which will be described below in detail.

The meteorological module 110 collects the general prediction data of a satellite service through an FTP information exchange server 102 and generates predictions for the next 72 hours for the specific area where the facility is located or from where the information has been requested.

The electric market module 116 collects the data coming from an electric grid server 104, referring to the public file market prices of the electric grid, including electricity prices, and generates predictions of the prices of each kilowatt-hour (Kwh) for the next 72 hours and supplies them to the database 106 such that they are stored, organized and can be supplied to the plant module 114.

The plant module 114 allows combining various element, design and configuration options of the facility together with the parameters provided by the remaining modules to provide an energy output to be produced.

The optimizing module 112 determines the best design or operating strategies of the plant 114 according to the data provided by the preceding modules and the criteria specified by the local user/users to the plant.

The system 100 provides a control unit 120 with a user interface 118 allowing the user 108 to configure the operating conditions of the thermal electric plant and to exploit the information generated by the expert modules (110, 112, 114, 116) and the data used in the calculations.

The optimization module 112 is configured to obtain the data referring to the electric energy market prices from the database 106 and to send simulation conditions to the plant module 114 according to the conditions configured by the user 108 through the user interface 118

The optimization module 112 additionally contains sub-modules which handle the data and generate the graphic representation of the meteorological parameters, the graphic representation of the market prices indicating the real and estimated values, which allows indicating the parameters necessary to perform the simulation of the solar field, warehouse, gas, block, restrictions and simulation criteria by means of a production plan, which allows indicating the configurations associated with the solar field, gas, salt tanks, block and operating modes and which allows analyzing and loading the real operating data of the plant, all for the purpose of meeting the objective of optimizing the operation of the plant.

The objective of the optimization performed by means of reiterated simulations is to meet the objective according to the selected criterion. The possible values and states of the plant are modified in the simulations in order to be able to meet the electricity sale objectives and maximize the exploitation of the plant with the prognosis and primary energy (solar resource) uncertainty.

The optimization process begins once the predictions and the uncertainties of meteorological values and electric market prices are known. The operator will then define state conditions of the plant and the possible restrictions within the time horizon of the optimization, which are both technical and operative due to different criteria. Once the optimization criterion is defined, the optimization module 112 will perform simulations and adjustments with feedback between its modules, and value adjustments until achieving the optimal production program according to the criterion and a foreseen scenario.

The optimization process is iterative and has a constant flow of values between its modules, handling the prognosis values and the associated uncertainties. Furthermore, once a better (meteorology or electricity price) prognosis is known, a new adjustment will be made to the production plan.

The system 100 allows the directors in charge of the exploitation of the power plant 114 to assign the resources and maintain high viability in the results and consumptions in the operation of the plant, being capable of handling a highly variable primary energy such as solar energy.

The optimization criteria are taken from the maximum energy sales revenues, so it is necessary to known the use of auxiliary fuel and the thermal storage administration.

The solar field is made up of loops as the basic units distributed into various subfields. Each loop is made up of units of solar collector assemblies (SCA) including the main systems, being able to give parameters and to govern regardless of the rest of the field. Additionally, the thermal and load losses of each element through which the fluid can circulate have been included in this model.

The plant module 114 allows the optimal dynamic evolution of the simulations and enables the activity of the control system and the transition modes in a real manner, synchronization and load curves, etc. The conventional part of the plant includes a steam generator, turbine stages, condensation and cooling tower, pre-heaters and degassers. The storage system and the auxiliary boiler, where appropriate, are constructed in the same manner.

The plant module 114 reproduces the control and the physical and dynamic characteristics of the plant, in combination with the appropriate prognosis of the electric demand and the solar resources, and is configured to obtain the prediction data from the database 106 and update the dynamic model of the plant, and to send the results of the simulation obtained according to the simulation conditions established by the optimization module 112.

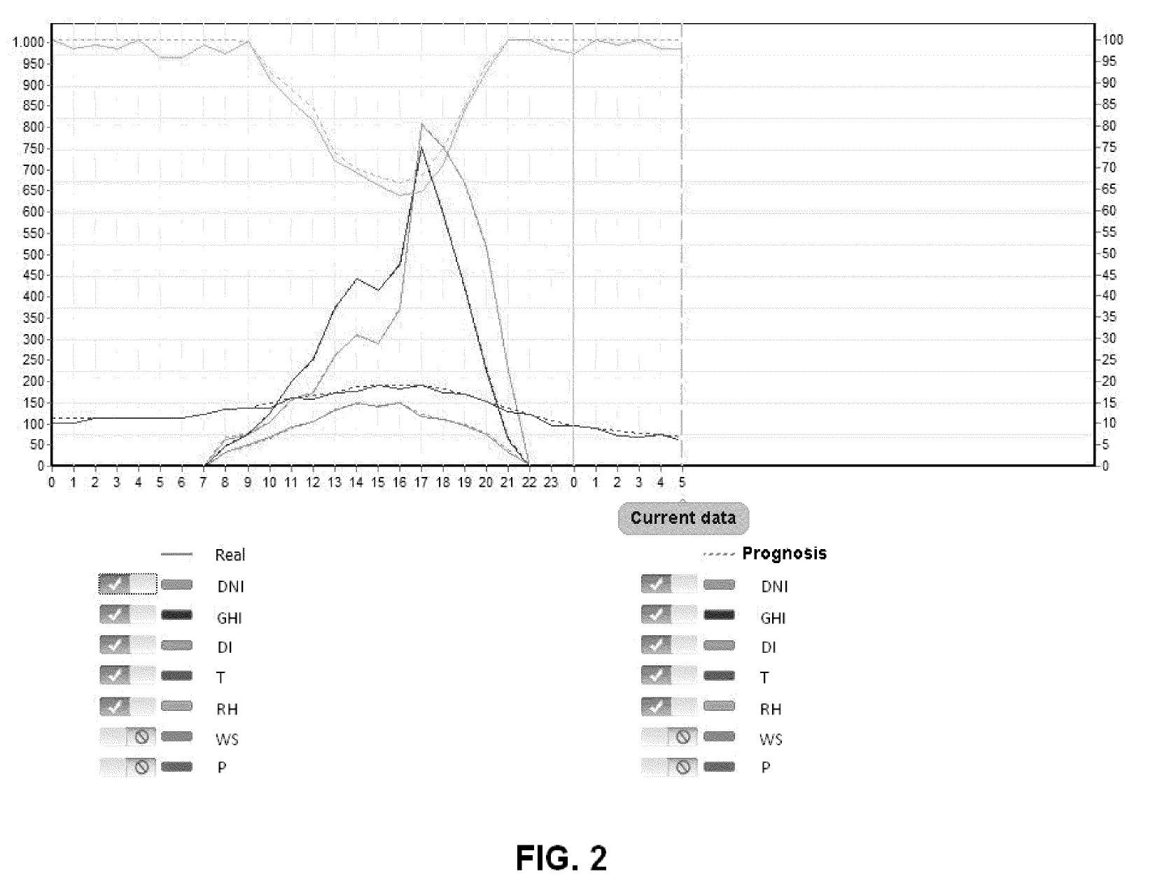

The system 100 provides two access profiles for the user 108 for the purpose of obtaining various functions and administration rights of the information of the system. The operator mode has access to the solar resource, electric market and production plan sub-modules shown in FIG. 2 managed by modules 112 and 116. All the available operations can be performed and the data can be accessed without any type of restriction in these modules.

The plant director mode has access to the same sub-modules as the operator, and also to the configuration and analysis sub-modules. All the available operations can be performed and the data can be accessed without any type of restriction in these modules.

The estimated and real data of the meteorological variables can be consulted from the solar resource sub-module, shown in FIG. 2, on an hourly basis up to the current date, and those corresponding to the forecasts for the next 72 hours. This data, which is read directly from the database 106, is collected by the meteorological module 110.

When the user wants to know information about the available solar resources by means of the user interface 118, there is a graph showing data from two days (the current day and the next day) simultaneously. The division between both is represented with a vertical solid line. The actual instance is represented with a vertical dotted line plus a visible mark on the x axis, where the current date and time are also shown. The x axis represents time (divided into 1 hour intervals), and the y axis is used to represent two scales of values (to the left and right).

The legend explaining the represented values is shown in the lower part of FIG. 2, the meteorological variables being distinguished by a solid or dotted line, according to whether they are real or estimated values, respectively. The real values are available until the current day and time at most, while the estimated values are offered for up to the following 72 hours. The maximum interval allowed only allows consulting data from 2 years ago up to the 3 days following the current date, the direct normal irradiation (DNI), the global horizontal irradiation (GHI), diffuse irradiation (DI) measured in W/m², and the dry bulb temperature (T, measured in ° C.), relative humidity (RH, measured in %), wind speed (WS, measured in Km/h) and atmospheric pressure (P, measured in mbar) are shown among the obtainable, controllable and modifiable values.

The real and estimated data of electric market prices can be consulted on an hourly basis by means of the interaction of the electric grid server 104, the electric market module 116 and the database 106. Real information is available up to the next 24 hours at most, and the estimated data is available up to the next 72 hours from the previous 24 hours, i.e., the system provides information up to a limit of 4 days from the current day. This data is the data collected by the electric market module 116, although the application reads it directly from the database 106 and as can be seen in the flowchart of FIG. 1, the information can be deployed towards the user interface 118.

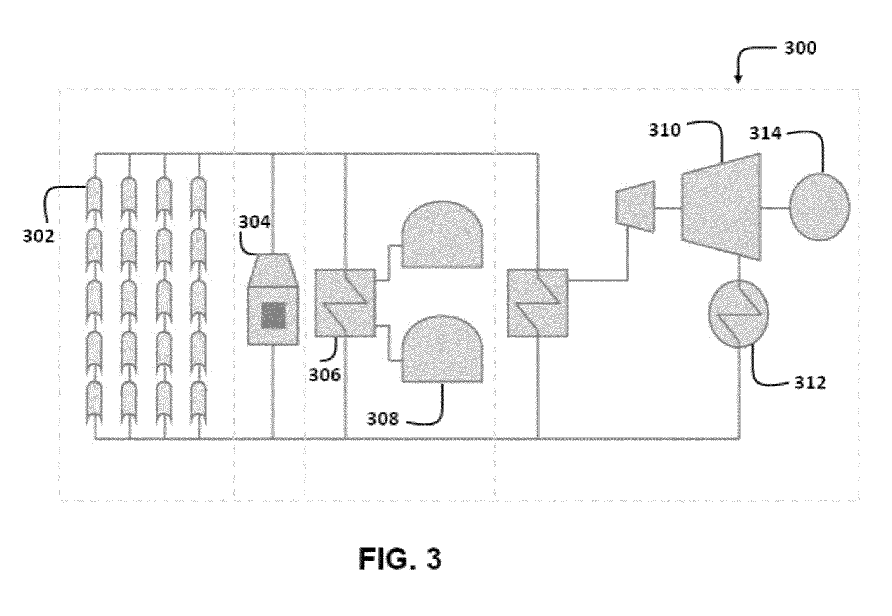

FIG. 3 shows a block diagram 300, of the plant module 114 on which the optimization module 112 will work in a feedback loop which, by means of the user interface 118, allows the user 108 to perform plant simulations based on the configurations of the plant module 114 with different scenarios by means of which it is possible to control the various parameters of each condition to be controlled or optimized, such as the case of the performance of the solar resource, warehouse, gas, block, and the respective criteria and restrictions, which can be interpreted by the block 302, by means of which the intention is to indicate that a number of values of the aforementioned elements and variables, such as for example the parameters of the solar field, such as the maximum and minimum sunrise or sunset thresholds, transmissibility, absorption, reflectivity, among others, can be controlled. Said values can be stored in a memory but they can also serve to configure the parameters.

The block 304 represents the auxiliary fuel boiler that can be used as support in the generation and operation of the plant. The gas parameters, which are used for anti-freezing and generation, among others, are configured. Restriction parameters are established by the former, by means of which the power data, such as the maximum and minimum power values for each hour, and the lower heating value (LHV), can be indicated.

The thermal storage blocks 306 and 308 include a group of elements consisting of: hot tank load, hot tank temperature and cold tank temperature, losses existing in the tanks, maximum and minimum tank volumes, salt density, among others.

The blocks represented by reference numbers 310, 312 and 314 represent, respectively, the initial turbine temperature and cold water temperature. Like in the previous case, the block parameters, such as the minimum and maximum temperatures and the cold, warm and hot start time, the power and/or performance degradation, among others, are configured by means of these blocks representing the orientation of the thermal electric plant.

According to the description of the invention provided above, it will be possible for experts skilled in the art to make obvious modifications without departing from the teachings and scope of the present invention, where said forms will be comprised by means of the foregoing description and the attached claims.

1. A system for optimizing the operation of solar plants, comprising:
a server responsible for collecting general prediction data of a data satellite service;
an electric grid server collecting data referring to electric energy market prices,
a control unit comprising:
a plurality of expert modules, including:
a meteorological module in communication with the server receiving the prediction data from the latter;
a plant module including a dynamic model of the plant which reproduces the physical and dynamic characteristics of the solar plant;
an electric market module for collecting the data coming from the electric grid server; and
an optimization module, from which the parameters relating to the operation of the solar plant are specified and optimized by reiterated simulations, in which the values and states of the plant are modified;
a database storing the prediction data obtained by the meteorological module and the data referring to the electric energy market prices coming from the electric market module;
a user interface allowing a user to access the information stored in the database, manipulate said information and work with each expert module to define the conditions suitable for operating and optimizing activities of the solar plant;
wherein the optimization module is configured to obtain the data referring to the electric energy market prices from the database and to send simulation conditions to the plant module according to the conditions configured by the user through the user interface;
and wherein the plant module is configured to obtain the prediction data from the database and update the dynamic model of the plant, and to send the results of the simulation obtained according to the simulation conditions established by the optimization module.

2. The system for optimizing the operation of solar plants according to claim 1, wherein the optimization module containing sub-modules which contain the data and generate the graphic representation of the meteorological parameters, the graphic representation of the market prices indicating the real and estimated values.

3. The system for optimizing the operation of solar plants according to claim 1, wherein the real operation of the plant being consulted by the plant module.

4. The system for optimizing the operation of solar plants according to claim 1, wherein the plant module allowing combining various element, design and configuration options of the facility together with the parameters provided by the remaining modules to provide an energy output to be produced.

5. The system for optimizing the operation of solar plants according to claim 1, wherein the plant module reproduces the control and the physical and dynamic characteristics of the plant, in combination with the appropriate prognosis of the electric demand and the solar resources.

6. The system for optimizing the operation of solar plants according to claim 1, the optimization module comprising a solar resource sub-module by which the estimated and real data of the meteorological variables are consulted, said data, which is read directly from the database, being collected by the meteorological module.

7. The system for optimizing the operation of solar plants according to claim 1, the prediction data comprising meteorological and radiation variables.

8. The system for optimizing the operation of solar plants according to claim 1, wherein the electric market module generates predictions of the prices of each kilowatt-hour and supplies them the predictions to the database such that the predictions are stored, organized and can be supplied to the plant module.
